(19) United States
(12) Patent Application Publication
(10) Pub. No.: US 2007/0062987 A1
(43) Pub. Date: Mar. 22, 2007

(54) BABY CARRIER

(75) Inventor: Toramatsu Murakami, Osaka (JP)

Correspondence Address: GREENBLUM & BERNSTEIN, P.L.C., 1950 ROLAND CLARKE PLACE, RESTON, VA, 20191, US

(73) Assignee: T-REX CO., LTD., Osaka (JP)

(21) Appl. No.: 11/460,300

(22) Filed: Jul. 27, 2006

(30) Foreign Application Priority Data
Sep. 16, 2005 (JP) 2005/271090

(51) Int. Cl. A61G 1/00; A61G 5/00

(52) U.S. Cl. 224/158; 224/159

(57) ABSTRACT

A baby carrier 1 entirely formed of a sheet member 12 and including a wrapping portion 16 for wrapping a baby/toddler and a shoulder engaging portion 15 engageable with a shoulder of a wearer of the baby carrier. The wrapping portion 16 is expandable. The wrapping portion 16 has an opening B for allowing the baby/toddler to enter or come out from the wrapping portion 16 at a top end thereof, and an opening edge 12aa of the opening B has expansion restriction means 17 for restricting expansion of the opening edge 12aa.

### TECHNICAL FIELD

The present invention relates to a baby carrier also referred to as a “baby/toddler sling” used for holding a baby or a toddler. (“BABYSLING” is a Japanese registered trademark of Crown Crafts Infant Products, Inc.)

### BACKGROUND ART

The above-mentioned baby carrier can be worn in various manners in accordance with the body size of the baby/toddler, the body size of a child care giver holding the baby/toddler, the use or the like. Owing to such a great convenience, the baby carrier is being more and more widely used.

Recently, baby carriers having a structure improved over a conventional structure are disclosed in documents.

For example, patent document 1 specified below discloses a “baby/toddler sling”.

The “baby/toddler sling” is spindle-shaped with both ends in the length direction being wrung. The baby/toddler sling includes a protection portion between both ends in the length direction for wrapping a baby/toddler. The protection portion is in bellows so as to be expandable. The ends in the length direction have coupling means for coupling the ends together.

Patent document 1 describes that the protection portion is in bellows and therefore is changeable in size so as to wrap a baby/toddler in accordance with the body size or the movement of the baby/toddler.

However, the baby/toddler sling described in patent document 1 has the following problems.

The protection portion is in bellows so as to be expandable, but both ends in the length direction are coupled together while being wrung. In addition, the protection portion of the baby/toddler sling is worn by a child care giver in a sash manner. When the child care giver wears the baby/toddler sling in the sash manner from one shoulder, a part of the baby/toddler sling corresponding to the body, especially a flank, of the child care giver closely touches the flank.

The length of the protection portion corresponds to the inter-end length, but the baby/toddler sling is worn in close touch with the child care giver. Therefore, the protection portion in bellows may not actually expand in the width direction sufficiently to match the size of the baby/toddler to be wrapped. In the worst case, the protection portion may be twisted.

For this reason, while the baby/toddler is wrapped in the protection portion, it is expected that his/her body, especially his/her head or legs located at the ends of the protection portion in the length direction, are compressed. In this case, the baby/toddler sling does not provide comfort to either the baby/toddler or the child care giver.

Such a protection portion cannot sufficiently wrap the baby/toddler. Therefore, for example, when the child care giver wearing the baby/toddler sling bends forward, the baby/toddler sling may not stably hold the baby/toddler.

When the baby/toddler sling is worn loosely so as not to closely touch the body of the child care giver, the protection portion expands downward because of the body weight of the baby/toddler.

When the baby/toddler is wrapped in the protection portion expanding downward, the neck or belly of the baby/toddler is forced to be bent excessively.

Since the baby/toddler sling is not stably attached to the body of the child care giver in this case, the child care giver does not feel comfortable.

The baby/toddler sling can be worn in, for example, a “vertical and facing” manner. In this case, the protection portion wraps only the back side (buttocks and back) of the baby/toddler; namely, the child care giver wears the baby/toddler sling so as to face the baby/toddler without the protection portion interposed therebetween.

In the case of the “vertical and facing” manner, the child care giver and the baby/toddler touch each other directly. The protection portion is not present between the child care giver and the baby/toddler. Therefore, the child care giver needs to constantly hold and keep the baby/toddler in close touch with his/her own body.

Patent document 2 specified below discloses a “baby/toddler holding belt” as an item relating to a baby carrier. The baby/toddler holding belt has the following structure. An inner cloth piece and an outer cloth piece are provided in layers, and are sewn together at one position in the length direction into a circle. The circular belt has a ring for binding the two pieces of cloth together.

The baby/toddler holding belt is used as follows. One of two parts of the circle between the ring and the sewing position is hung on the shoulder, and the other part is used for holding the baby/toddler.

The baby/toddler holding belt described in patent document 2 is formed of two overlapping pieces of cloth as described above, and therefore can be positively expanded in the width direction. Thus, the baby/toddler holding belt can hold the baby/toddler stably.

The belt, which is formed of two pieces of cloth, can be easily expanded in the width direction. However, the two pieces of cloth merely overlapping each other may be dislocated from each other when, for example, the baby/toddler moves while the child care giver is wearing the belt.

Thus, the baby/toddler holding belt has a problem in terms of safety of the baby/toddler. This requires the child care giver to support the baby/toddler from below with at least one arm (see FIG. 1 of patent document 2). Depending on the way of holding, the two pieces of cloth may easily be dislocated from each other. This restricts the way of holding.

Patent document 1: Japanese Laid-Open Patent Publication No. 2003-47542

Patent document 2: Japanese Laid-Open Utility Model Publication No. 5-20665

### DISCLOSURE OF INVENTION

### Problems to be Solved by the Invention

Accordingly, the present invention has an object of providing a baby carrier which guarantees the safety of a baby/toddler and is comfortably usable by a child care giver and the baby/toddler.

### MEANS FOR SOLVING THE PROBLEMS

The invention of claim 1 relates to a baby carrier entirely formed of a sheet member and including a wrapping portion for wrapping a baby/toddler and a shoulder engaging portion engageable with a shoulder of a wearer of the baby carrier. The wrapping portion is formed to be expandable. The wrapping portion has an opening for allowing the baby/toddler to enter or come out from the wrapping portion at a top end thereof, and an opening edge of the opening has expansion restriction means for restricting expansion of the opening edge.

According to one example in which the sheet member, especially the wrapping portion, is formed to be expandable, the sheet member is formed of a knit material.

Specifically, the wrapping portion may be formed by, for example, weft knitting, Denbigh knitting (tricot) or other forming methods for guaranteeing expandability.

The wrapping portion may be formed of, for example an expandable material such as nylon or the like.

In the case where the sheet member, especially the wrapping portion, is formed of a knit material as described above, the sheet member can be guaranteed to have expandability even if the sheet member is formed of a non-expandable material, because tissue of the knit material is expandable.

Alternatively, the wrapping portion may be formed of an expandable material such as a rubber sheet or the like.

In the case where the sheet member, especially the wrapping portion, is formed of an expandable material, the sheet member can be guaranteed to have expandability because the material itself is expandable.

The top end of the wrapping portion or the sheet member is an edge corresponding to the top end of the baby carrier in the width (up-down) direction of the wrapping portion in the case where, for example, the baby carrier is worn by a child care giver in a “cradle” manner.

The expansion restriction means for restricting the expansion of the opening edge can be formed of, for example, stitches (sewing portion). The stitches formed along the opening edge can restrict the expansion of the portion provided with the stitches. As a result, the expansion of the opening edge can be restricted.

An expandable thread may be used for forming the stitches. Even in such a case, the expansion of the opening edge can be restricted.

In the case where an expandable thread, for example, a nylon thread is used, the thread is prevented from breaking for the following reason. Since the thread in the restricted portion is expanded properly even if the expansion thereof is restricted by the expansion restriction means, the tensile force acting on the thread is absorbed.

The stitches may be formed in the state where the opening edge is tucked or pleated as described below.

The expansion restriction means encompasses means for restricting expansion by thermally changing the shape of the opening edge by heating. The expansion restriction means also encompasses piping or stitching the opening edge.

According to the invention of claim 1, the wrapping portion is expandable. Therefore, when wrapping the baby/toddler, the wrapping portion is expanded in accordance with the body shape of the baby/toddler. For this reason, the wrapping portion closely touches the baby/toddler and the child care giver, and thus can stably wrap the baby/toddler even if the baby/toddler moves.

Owing to the above-described structure, even if the baby/toddler stands up in the wrapping portion, the wrapping portion is expanded to become deeper. Therefore, the wrapping portion can protect the baby/toddler so as not to fall outside.

Also owing to the above-described structure, the baby/toddler does not feel compressed.

The wearer of the baby carrier can allow the baby/toddler in the wrapping portion to closely touch the body of the wearer himself/herself.

Therefore, the load acting on the wearer when the wearer holds the baby/toddler can be minimized, and the stability of the baby/toddler accommodated in the wrapping portion can be improved.

The opening edge of the opening has expansion restriction means. Therefore, the opening edge can be restricted so as not to be excessively expanded or becoming loose.

Accordingly, although the wrapping portion is expandable, the opening can be prevented from becoming excessively large. Thus, the baby/toddler does not fall down through the opening.

According to the invention of claim 2, it is preferable that the sheet member is formed of one piece of expandable cloth into a ring shape, and that the sheet member is folded along an intermediate portion in a width direction thereof to have a two-layer structure.

In the case where the sheet member is formed of one piece of expandable cloth into a ring shape, the baby carrier can be easily worn in the sash manner with no need to couple or separate parts of the sheet member using a coupling member such as a buckle each time the baby carrier is put on or taken off.

The sheet member is folded along the intermediate portion thereof in the width direction to have a two-layer structure, without a sewing portion being formed in the wrapping portion. Therefore, the expansion of the wrapping portion is inhibited by the sewing portion.

Accordingly, the wrapping portion can be flexibly expanded in accordance with the body shape of the baby/toddler, and thus the baby/toddler feels more comfortable in the wrapping portion.

The wrapping portion wraps the baby/toddler on his/her back, and is also present between the baby/toddler and the child care giver and thus also wraps the baby/toddler on this side. Therefore, the baby/toddler is protected against sliding off between, for example, the child care giver and the wrapping portion.

According to the invention of clam 3, the opening edge is preferably shorter than a part of the sheet member having the greatest length in a circumferential direction thereof.

In the case where the opening edge is shorter than the part of the sheet member having the greatest length in a circumferential direction thereof, the opening can be kept small even when the wrapping portion is expanded. Thus, the baby/toddler in the wrapping portion can be held so as not to fall down through the opening.

According to one exemplary preferable structure for forming the opening edge to be shorter than the part of the sheet member having the greatest length in a circumferential direction thereof, the expansion restriction means for restricting the expansion of the opening edge is formed of at least one tucked portion.

Alternatively, the opening edge can be shorter by folding a predetermined portion thereof to have peaks and troughs alternately and sewing the folded portions to be pleated.

The expansion restriction means for restricting the expansion of the opening edge may be formed of a lengthy member such as a tape, a belt, a rubber string or the like, fixing means such as a buckle, a hook, a snap, a surface fastener, a sliding fastener, a button or the like, or a combination thereof.

In the case where the expansion restriction means for restricting the expansion of the opening edge is formed of tucked portions or pleated portions as described above, the opening edge can be kept shorter than the length of the sheet member in the circumferential direction thereof and also the opening edge can be restricted from being excessively expanded.

The expansion restriction means for restricting the expansion of the opening edge, which is formed of tucked portions or pleated portions, can be easily formed basically by merely sewing a part of the opening edge, without providing a separate member for restricting the expansion.

According to the invention of claim 6, the expansion restriction means may be provided in an area between the wrapping portion and the shoulder engaging portion in a circumferential direction of the sheet member, for restricting expansion of the area.

The expansion restriction means for restricting the expansion of the area between the wrapping portion and the shoulder engaging portion encompasses forming a sewing portion, piping or stitching as described above regarding the opening edge. The expansion can be restricted by thermally changing the shape of the area by heating also as described above regarding the opening edge.

In the case where the expansion restriction means is provided for restricting the expansion of the area between the wrapping portion and the shoulder engaging portion in the circumferential direction of the sheet member, the following effect is provided. The area between the wrapping portion and the shoulder engaging portion, which is likely to receive a load especially when the baby carrier is worn in the sash manner, can be restricted so as not to be excessively expanded. As a result, the baby carrier is prevented from being deformed (e.g., the wrapping portion is prevented from sliding down), and from being destroyed.

It is especially preferable that expansion restriction means for restricting the expansion of the area between the wrapping portion and the shoulder engaging portion is formed at a top end of the area (closer to the opening edge) and a bottom end of the area (closer to the portion along which the sheet member is folded into two in the width direction) of the area. In such a case, the expansion of the sheet member can be more certainly restricted owing to the expansion restriction means at the top end and the bottom end.

In the case where the expansion restriction means for restricting the expansion of the opening edge is formed at the opening edge between the shoulder engaging portion and the wrapping portion in the circumferential direction of the sheet member, the following effect is provided. The expansion restriction means for restricting the expansion of the opening edge can restrict the expansion of the area of the sheet member between the wrapping portion and the shoulder engaging portion, from the top end of the area.

According to the invention of claim 7, the area of the sheet member between the wrapping portion and the shoulder engaging portion in a circumferential direction of the sheet member is preferably formed to become gradually narrower toward the shoulder engaging portion from the wrapping portion.

With such a structure, the shoulder engaging portion has a width corresponding to the shoulder of the wearer. Therefore, the baby carrier is more easily hung on the shoulder in a satisfactory manner, and also provides a good external appearance.

In the case where the area of the sheet member between the wrapping portion and the shoulder engaging portion is formed to become gradually narrower, a load can be prevented from concentratedly acting on one part thereof.

According to the invention of claim 8, a portion of the sheet member corresponding to the front part of outfit of the wearer and a portion of the sheet member corresponding to the rear part of the outfit of the wearer may have shapes generally matching each other when overlapping each other.

With such a structure, the baby carrier can be in close touch with the front part and the rear part of the outfit of the wearer. Thus, the stability of the baby/toddler accommodated in the wrapping portion is improved.

According to the invention of claim 9, it is preferable that the shoulder engaging portion of the sheet member includes a sewing portion, and that the shoulder engaging portion is provided with a shoulder pad.

In the case where the shoulder engaging portion of the sheet member includes a sewing portion, the shoulder engaging portion can be restricted so as not to be unnecessarily expanded. The shoulder engaging portion, which is especially likely to receive a load, can be reinforced.

For producing a baby carrier, a planar sheet member is formed into a ring shape. The ring shape can be formed by sewing the sheet member in the shoulder engaging portion.

In the case where the sewing portion is formed in the shoulder engaging portion, a portion of the sheet member corresponding to the front part of the outfit of the wearer and a portion of the sheet member corresponding to the rear part of the outfit of the wearer can have shapes generally matching each other, and thus can be formed of elements of the same shape of the sheet member.

Therefore, the baby carrier can be produced at lower cost and higher work efficiency.

Even though the shoulder engaging portion has the sewing portion, provision of the shoulder pad prevents the sewing portion from locally contacting the shoulder of the wearer when the shoulder engaging portion is engaged with the shoulder, and thus guarantees the comfort of the wearer without causing him/her to feel that something does not fit at the shoulder.

### BRIEF DESCRIPTION OF DRAWINGS

FIG. 1 is an external view illustrating a baby carrier in this embodiment being worn.

FIG. 2 is an external view of the baby carrier in this embodiment.

FIG. 3 is a front view of the baby carrier in this embodiment.

FIG. 4 is a right side view of the baby carrier in this embodiment.

FIG. 5 is a left side view of the baby carrier in this embodiment.

FIG. 6 is a plan view of the baby carrier in this embodiment.

FIG. 7 is a bottom view of the baby carrier in this embodiment.

FIG. 8 is a cross-sectional view of FIG. 3 along line X-X.

FIG. 9 is a cross-sectional view of FIG. 3 along line Y-Y.

FIG. 10 is a front view of the baby carrier in this embodiment in a spread state.

FIG. 11 is a right side view of the baby carrier in this embodiment in the spread state.

FIG. 12 is a plan view of the baby carrier in this embodiment in the spread state.

FIG. 13 is a bottom view of the baby carrier in this embodiment in the spread state.

FIG. 14 is a view illustrating a method for producing the baby carrier in this embodiment.

FIG. 15 is an external view of the baby carrier in this embodiment worn in a sash manner.

FIG. 16 is a view illustrating one manner of use of the baby carrier in this embodiment.

FIG. 17 is a view illustrating another manner of use of the baby carrier in this embodiment.

FIG. 18 is a view illustrating how the baby carrier in this embodiment works.

FIG. 19 is a view illustrating a still another manner of use of the baby carrier in this embodiment.

FIG. 20 is a view illustrating a still another manner of use of the baby carrier in this embodiment.

### DESCRIPTION OF REFERENCE NUMERALS

11 Baby carrier

12 Sheet member

13 Outer cloth sheet

14 Inner cloth sheet

15 Shoulder engaging portion

16 Wrapping portion

17a, 17b, 17c Tucked portion

12aa Opening edge (top edge)

21 Bottom sewing portion

22 Shoulder sewing portion

23 Shoulder pad

B Opening

### BEST MODE FOR CARRYING OUT THE INVENTION

Hereinafter, one embodiment of the present invention will be described with reference to the drawings.

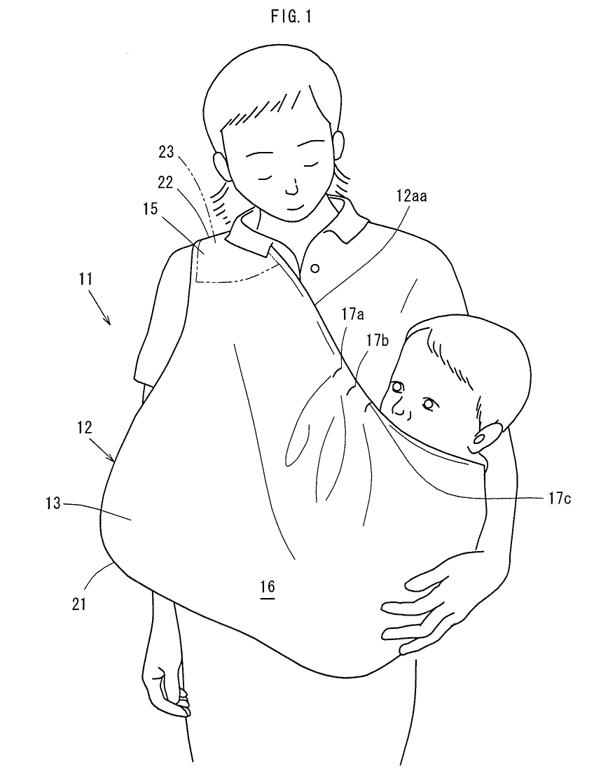

FIG. 1 shows a baby carrier 11 in this embodiment worn by a child care giver in a so-called “cradle” manner.

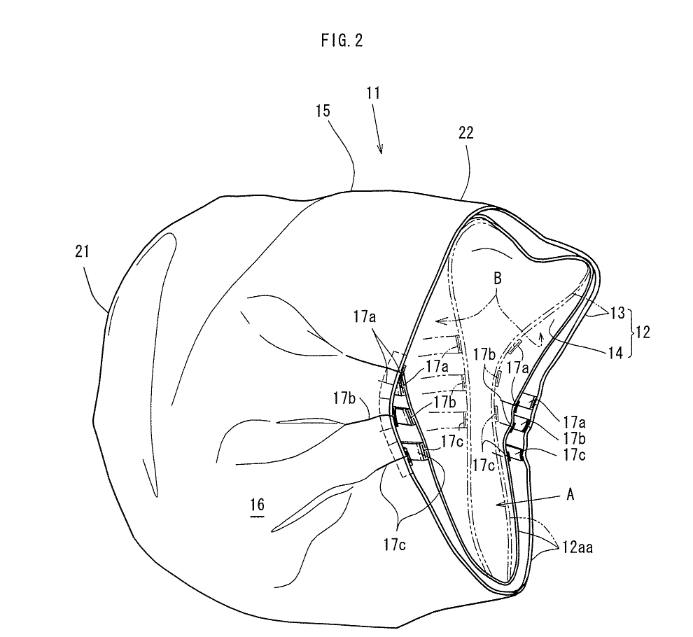

A baby carrier 11 shown in FIG. 1 is entirely formed of a sheet member 12, which has a two-layer structure including planar cloth sheets overlapping each other. As shown in FIG. 2, the sheet member 12 includes an outer cloth sheet 13 and an inner cloth sheet 14.

The sheet member 12 is knit and is obtained by combining nylon, which is superb in expandability and elasticity, and cotton which provides a comfortable feel to the skin.

During the production of the baby carrier 11, nylon and cotton may be combined while still being filaments or after being formed into threads.

The sheet member 12, which includes nylon and is entirely knit as described above, provides superb expandability.

The sheet member 12 may be formed of any type of filament or thread which provides superb expandability, for example, an elastic polyurethane thread.

The sheet member 12 may be formed by any other method which guarantees expandability, for example, weft knitting such as circular knitting, warp knitting such as Denbigh knitting (tricot) or raschel lacing, or rib knitting.

The sheet member 12 may be formed of another material, instead of cotton, which provides a comfortable feel to the skin, for example, cashmere, wool or silk.

As shown in FIG. 2, the baby carrier 11 is formed to be cylindrical (tubular) with a through-hole A for wearing, which allows the child care giver to wear the baby carrier 11 in the sash manner.

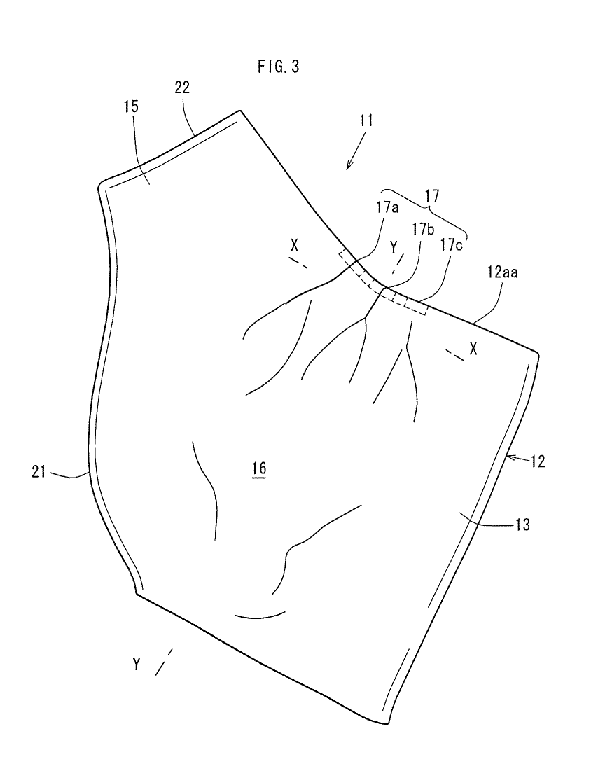

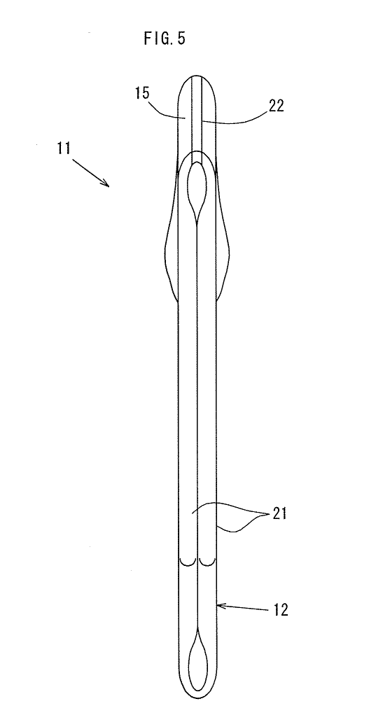

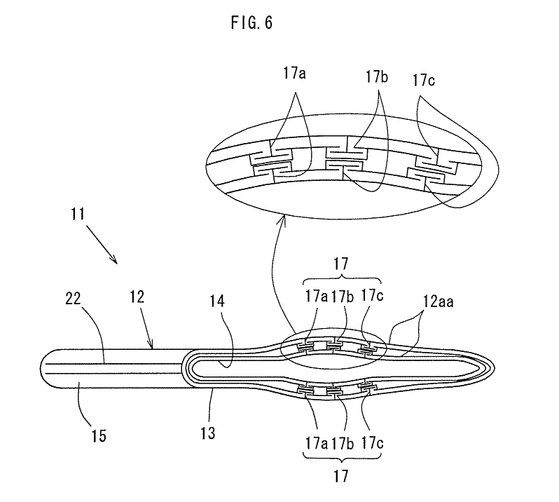

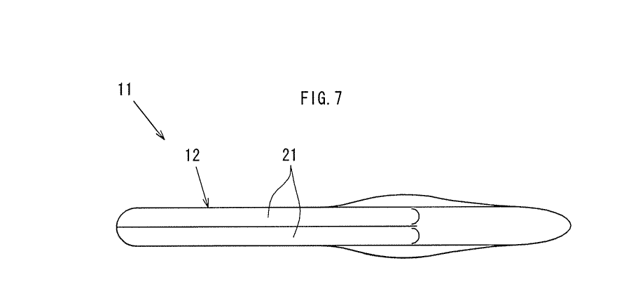

As shown in FIG. 3 through FIG. 7, the baby carrier 11 includes a shoulder engaging portion 15 in a part in a circumferential direction thereof. The shoulder engaging portion 15 has a width which is sufficiently large to engage the baby carrier 11 with the right or left shoulder of the child care giver.

FIG. 3 through FIG. 7 are respectively a front view, a right side view, a left side view, a plan view and a bottom view of the baby carrier 11 when two planar parts thereof facing each other are put into contact with each other while interposing the through-hole A for wearing therebetween.

A rear view of the baby carrier 11 is symmetrical to the front view and will be omitted.

The baby carrier 11 includes a wrapping portion 16 capable of wrapping a baby/toddler. When the child care giver wears the baby carrier 11 in the sash manner, the wrapping portion 16 corresponds to the front part and the rear part of his/her outfit.

As shown in FIG. 3, a portion between the shoulder engaging portion 15 and the wrapping portion 16 in the circumferential direction of the baby carrier 11 is formed to be narrower toward the shoulder engaging portion 15 from the wrapping portion 16.

The baby carrier 11 has an opening B at a top end of the wrapping portion 16 (see FIG. 2) for allowing the baby/toddler to enter or come out from the baby carrier 11 worn by the child care giver in the sash manner.

When the child care giver wears the baby carrier 11 in the “cradle” manner as shown in FIG. 1, the opening B has an opening edge 12aa at the top end of the wrapping portion 16.

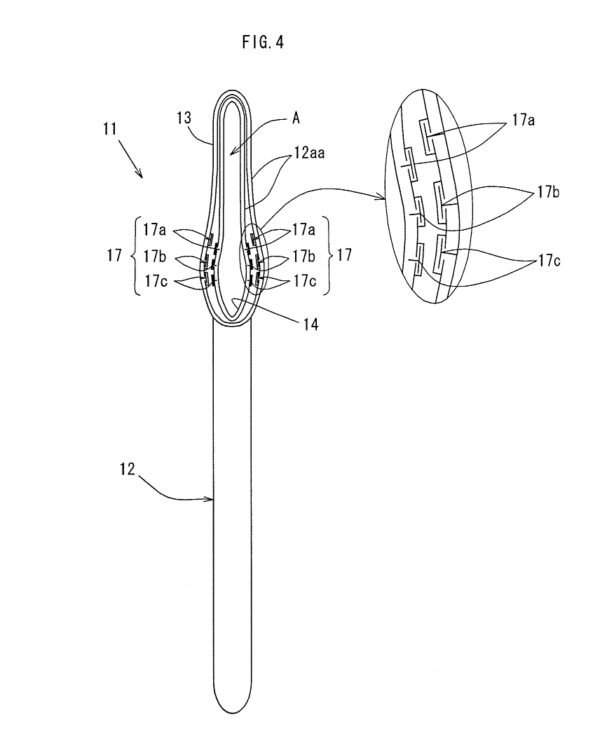

As shown in FIG. 3 and the enlarged part of FIG. 4, the baby carrier 11 includes tuck forming portions 17 along the opening edge 12aa between the shoulder engaging portion 15 and the wrapping portion 16 in the circumferential direction thereof.

The tuck forming portions 17 are formed on the outer cloth sheet 13 and the inner cloth sheet 14 of the sheet member 12 at positions corresponding to the front part and the rear part of the outfit of the child care giver. There are four tuck forming portions 17 along the opening edge 12aa. Each tuck forming portion 17 includes three tucked portions 17a, 17b and 17c.

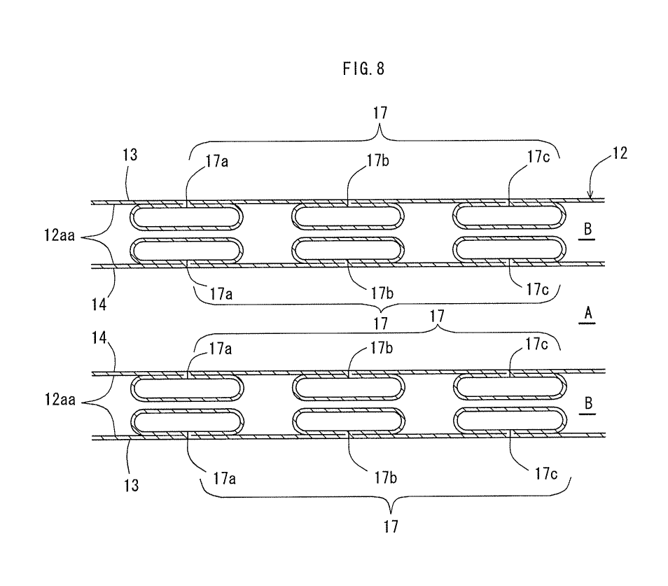

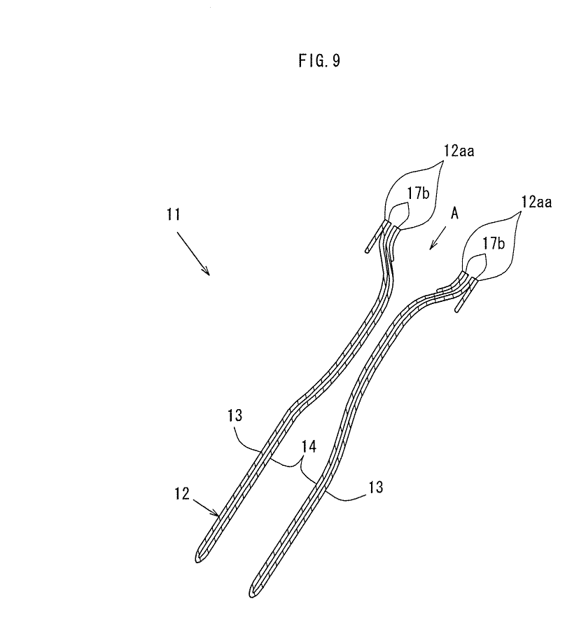

As shown in FIG. 8 and FIG. 9, the sheet member 12 has grooves at positions corresponding to the tucked portions 17a, 17b and 17c. In this way, the entire wrapping portion 16 can be formed to be loose and three-dimensional so as to easily wrap the baby/toddler.

FIG. 8 shows a cross-section of FIG. 3 along line X-X, and FIG. 9 shows a cross-section of FIG. 4 along line Y-Y.

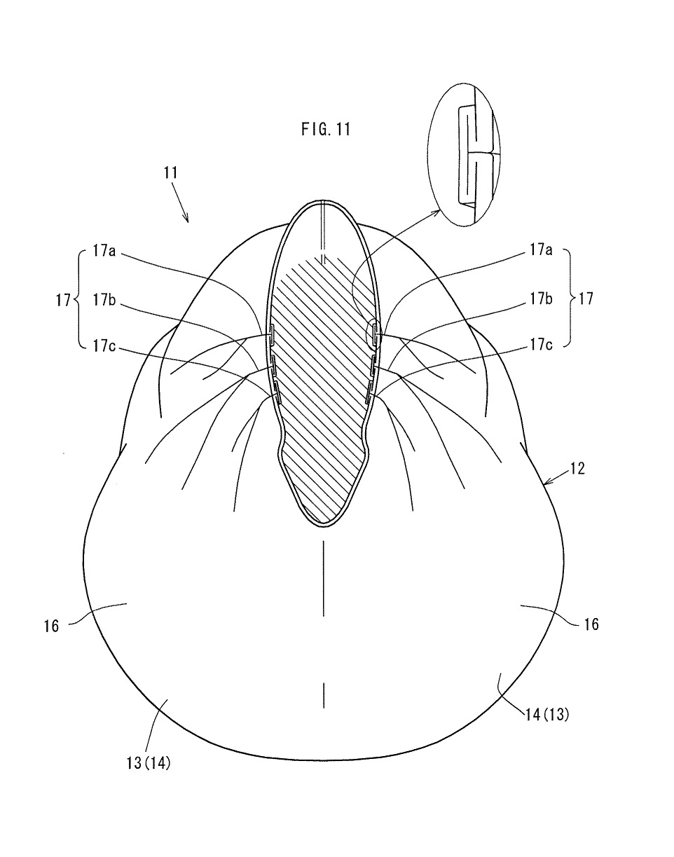

The tucked portions 17a, 17b and 17c are each formed by nipping a part of the opening edge 12aa and sewing the nipped part and the periphery thereof in an overlapping state (see the enlarged part of FIG. 11).

The opening edge is wrung in this way, and thus is shorter than a circumferential length of a lower part of the sheet member 12.

Instead of the tucked portions 17a, 17b and 17c, the opening edge 12aa may have a lengthy member such as a tape, a belt, a rubber string or the like, fixing means such as a buckle, a hook, a snap, a surface fastener, a sliding fastener, a button or the like, or a combination thereof. Alternatively, the opening edge 12aa may be thermally changed in shape by heating. Still alternatively, the opening edge 12aa may be folded, or pleated to have peaks and troughs alternately, so as to be expandable. In this manner, the opening edge 12aa can have means for restricting the expansion thereof so as to prevent the opening from being unnecessarily large.

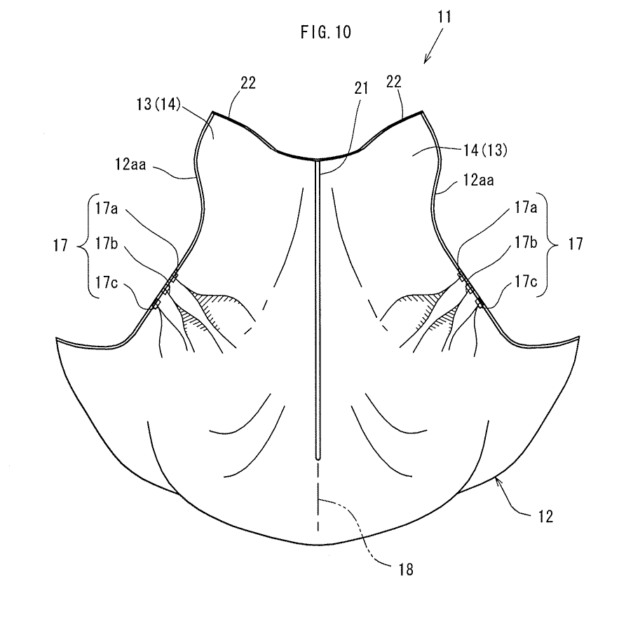

With reference to FIG. 10 through FIG. 13, the structure of the baby carrier 11 will be described based on a form thereof in the case where the sheet member 12 having the two-layer structure is developed into a one-layer structure, i.e., in the case where the outer cloth sheet 13 and the inner cloth sheet 14 overlapping each other are separated from each other.

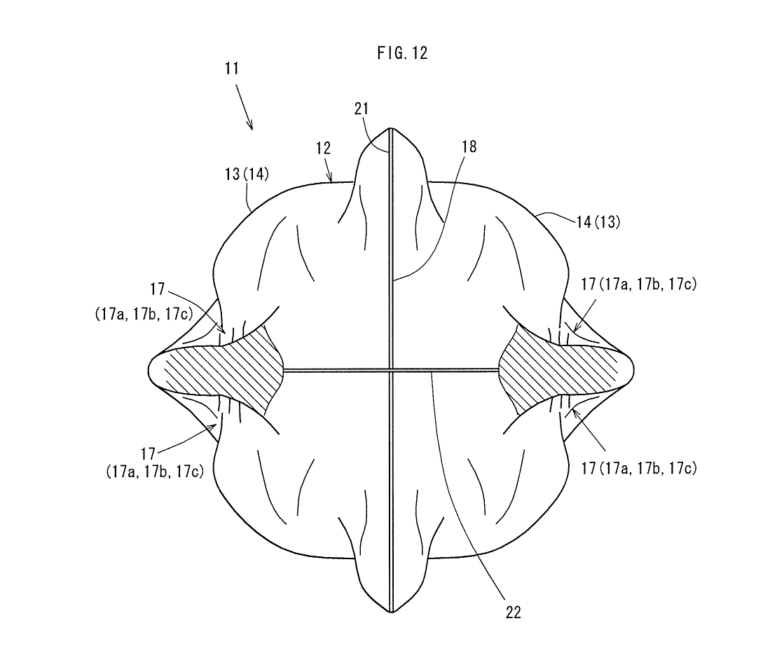

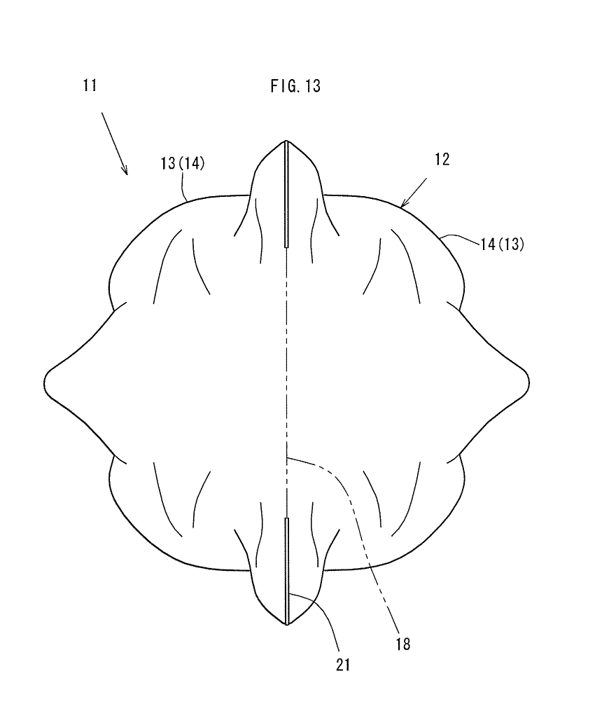

FIG. 10 is a front view or a rear view of the baby carrier 11 developed as described above. FIG. 11, FIG. 12 and FIG. 13 are respectively a right side view, a plan view and a bottom view of the baby carrier 11. The left side view of the baby carrier 11 is the same as the right side view and will be omitted.

When the sheet member 12 having the two-layer structure is developed into a one-layer structure, the outer cloth sheet 13 and the inner cloth sheet 14 are symmetrical with respect to a center line 18 extending in an up-down direction.

Although not shown, the sheet member 12 is planar before being sewn. Both ends thereof in the length direction are sewn together to form a shoulder sewing portion 22. In the state where the sheet member 12 is formed to have the two-layer structure, the shoulder sewing portion 22 is located at the shoulder engaging portion 15.

The inner cloth sheet 14 is foldable inside the outer cloth sheet 13 along the center line 18.

Whichever of the cloth sheets provided on both sides of the center line 18 as described above may be folded inside the other cloth sheet, the same two-layer structure can be formed. In such a two-layer structure of the ring-shaped baby carrier 11, the cloth sheet located outside is the outer cloth sheet 13, and cloth sheet located inside is the inner cloth sheet 14.

In the state where the outer cloth sheet 13 and the inner cloth sheet 14 overlap each other, the center line 18 of the sheet member 12 is located at the bottom of the baby carrier 11.

The sheet member 12 includes a sewing portion 21 on and both sides of the center line 18 except in the wrapping portion 16. The sewing portion 21 is located at the bottom of the baby carrier 11 when the sheet member 12 is formed into the two-layer structure, and thus acts as a bottom sewing portion 21.

The sewing portion 21 can be provided with stitches or piping optionally. Such stitches or the like provided in the sewing portion 21 allow the outer cloth sheet 13 or the inner cloth sheet 14 to be easily folded and overlap.

In the case where the sheet member 12 has the two-layer structure, the bottom sewing portion 21 on the center line 18 is not located at the bottom end of the wrapping portion 16 in the circumferential direction but is located at the bottom end of an area between the shoulder engaging portion 15 and the wrapping portion 16 (see FIG. 3).

The baby carrier 11 in this embodiment has the above-described structure.

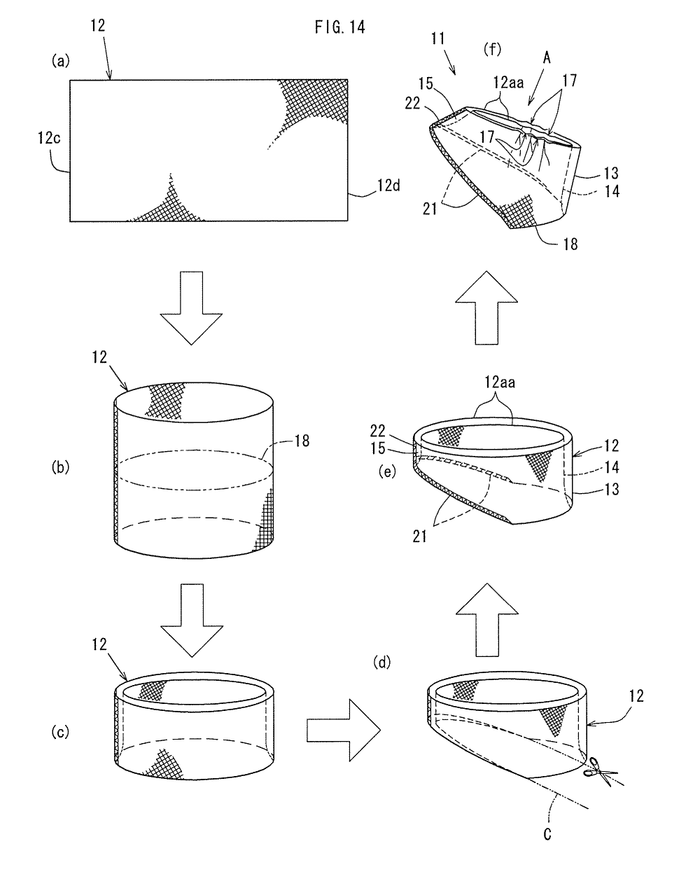

Next, an exemplary method for producing the baby carrier 11 described above will be briefly described with reference to FIG. 14.

(1) As shown in FIG. 14(a), one sheet member 12 of a knit material is cut into a rectangular shape.

(2) As shown in FIG. 14(b), two ends of the sheet member 12 in the longitudinal direction are sewn together to form a ring shape (cylindrical shape).

(3) As shown in FIG. 14(c), the sheet member 12 is folded along the center line 18 in the width direction (up-down direction). Specifically, the bottom half of the sheet member 12 in the up-down direction is folded to be inside the top half. Thus, the folding part (folding line) is positioned at the bottom end of the sheet member 12 having the two-layer structure.

(4) As shown in FIG. 14(d), a part of the folding part of the sheet member 12 is cut along phantom line C.

(5) As shown in FIG. 14(e), the outer cloth sheet 13 and the inner cloth sheet 14 are sewn together along the cutting line.

(6) As shown in FIG. 14(f), four tuck forming portions 17 are formed along the opening edge 12aa (top end) of the sheet member 12.

The baby carrier 11 in this embodiment is produced by the above steps (1) through (6).

Next, a procedure by which a child care giver puts on the baby carrier 11 in a “cradle” manner shown in FIG. 1 will be described.

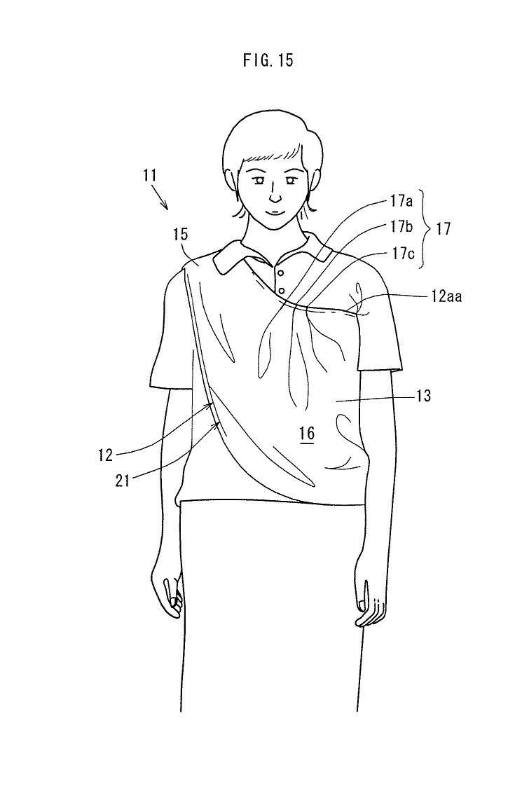

First, as shown in FIG. 15, the child care giver puts on the baby carrier 15 in the sash manner such that the shoulder engaging portion 15 is on, for example, his/her right shoulder.

The child care giver can easily put on the baby carrier 11 by merely hanging the baby carrier 11 on his/her shoulder in the sash manner.

Then, while holding the baby/toddler in one arm, the child care giver separates the outer cloth sheet 13 and the inner cloth sheet 14 forming the wrapping portion 16 of the sheet member 12 along the opening edge 12aa with the other arm.

Thus, the child care giver can open the opening B (see FIG. 2) at the top end of the wrapping portion 16. Then, as shown in FIG. 1, the child care giver can accommodate the baby/toddler in the wrapping portion 16.

The baby carrier 11 in this embodiment, when holding the baby/toddler in the wrapping portion 16 as described above, provides the following functions and effects.

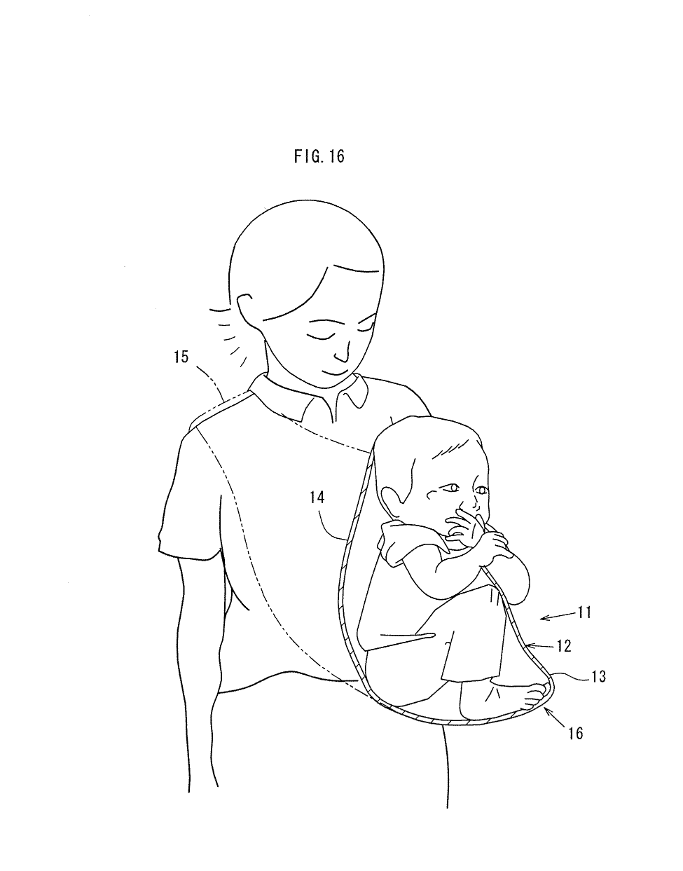

In this embodiment, the wrapping portion 16 has expandability (elasticity) and does not have the bottom sewing portion 21 at the bottom end thereof. Therefore, as shown in FIG. 16, the wrapping portion 16 can be changed in shape in accordance with the body shape of the baby/toddler.

Accordingly, body parts of the baby/toddler such as buttocks and the like can closely touch the wrapping portion 16. Thus, the baby/toddler is stable in the wrapping portion 16. Since the wrapping portion 16 is expandable, the baby/toddler does not feel compressed.

The tuck forming portions 17 are provided along the opening edge 12aa of the opening B. The tuck forming portions 17 have stitches, which restrict the expansion of the opening edge 12aa.

The tuck forming portions 17 restrict the opening edge 12aa from excessively expanding or getting loose.

The tuck forming portions 17 wring the opening edge 12aa, and therefore keep the opening edge 12aa short and the opening B small.

As described above, the wrapping portion 16 is expandable, but the opening B does not become excessively large even when the baby/toddler puts his/her weight on the opening edge 12aa. Thus, the baby/toddler is prevented from falling down through the opening B.

For allowing the baby/toddler to enter or come out from the wrapping portion 16, the child care giver can easily enlarge the opening B as intended.

With the baby carrier 11 in this embodiment, the tuck forming portions 17 are provided in an area between the shoulder engaging portion 15 and the wrapping portion 16 in the circumferential direction. With such a structure, this area, which is likely to receive a load when the child care giver puts on the baby carrier 11, is reinforced, and the baby carrier 11 can be kept non-deformed.

Accordingly, the baby/toddler in the wrapping portion 16 is prevented from being forced to bend the neck or being compressed in the belly.

The baby carrier 11 in this embodiment is formed of one expandable sheet member 12, which is formed into a ring shape so as to touch the front part and the rear part of the outfit of the child care giver.

Therefore, the baby carrier 11 can wrap the entire body of the baby/toddler in close touch with the child care giver without causing the baby/toddler to fall down.

Owing to the recovery force (elasticity) of the wrapping portion 16 expanded by the body weight of the baby/toddler, the child care giver can keep the body of the baby/toddler in close touch with his/her own body with no need to positively hold the baby/toddler.

Accordingly, the child care giver strongly feels being together with the baby/toddler, and still the load on the body of the child care giver holding the baby/toddler can be minimized.

As described above, the outer cloth sheet 13 and the inner cloth sheet 14 are symmetrical to each other, and are sewn together along the bottom sewing portion 21. Owing to such a structure, the baby carrier 11 can be produced at lower cost and higher work efficiency.

The shoulder engaging portion 15 has the shoulder sewing portion 22. Therefore, a part of the sheet member 12 corresponding to the front part of the outfit of the child care giver, and a part thereof corresponding to the rear part of the outfit of the child care giver, can be formed of elements of the same shape of the sheet member 12. Thus, these parts can be produced at the same time.

Accordingly, the baby carrier 11 can be produced at lower cost and higher work efficiency.

As described above, the bottom sewing portion 21 is at the bottom of the sheet member 12, and the tuck forming portions 17 for restricting the expansion of the opening edge 12aa are at the top end of the sheet member 12.

Also as described above, the bottom sewing portion 21 and the tuck forming portions 17 are both formed between the shoulder engaging portion 15 and the wrapping portion 16 in the circumferential direction of the sheet member 12.

Therefore, the bottom sewing portion 21 and the tuck forming portions 17 can reinforce the area between the shoulder engaging portion 15 and the wrapping portion 16 in the circumferential direction, at the top and bottom ends of the area.

Accordingly, the area between the shoulder engaging portion 15 and the wrapping portion 16 in the circumferential direction, which is likely to receive a load when the child care giver puts on the baby carrier 11 and is narrow, is prevented from being excessively expanded or destroyed.

The baby carrier 11, which can be washed with water in the state where the two planar sheets 13 and 14 are separated from each other, is highly hygienic. Owing to the bottom sewing portion 21, the sheet member 12 can be recovered to have the two-layer structure along the bottom sewing portion 21 after being washed.

Next, the wearing state of the baby carrier 11 will be described from the point of view of the child care giver.

The shoulder engaging portion 15 has a width corresponding to the shoulder of the child care giver, and therefore can touch the shoulder of the child care giver two-dimensionally. In addition, the shoulder engaging portion 15 of the sheet member 12 is expandable. Therefore, the child care giver can wear the baby carrier 11 comfortably.

As represented with phantom line in FIG. 1, the shoulder engaging portion 15 may be provided with a shoulder pad 23. The shoulder pad 23 may be formed to be detachable by using fixing means such as a surface fastener or the like. Provision of the shoulder pad 23 prevents the shoulder sewing portion 22 of the shoulder engaging portion 15 from locally contacting the shoulder.

Therefore, the child care giver can wear the baby carrier 11 more comfortably without feeling that something does not fit at the shoulder.

The child care giver can wear the baby carrier 11 in various manners other than the “cradle” manner described above.

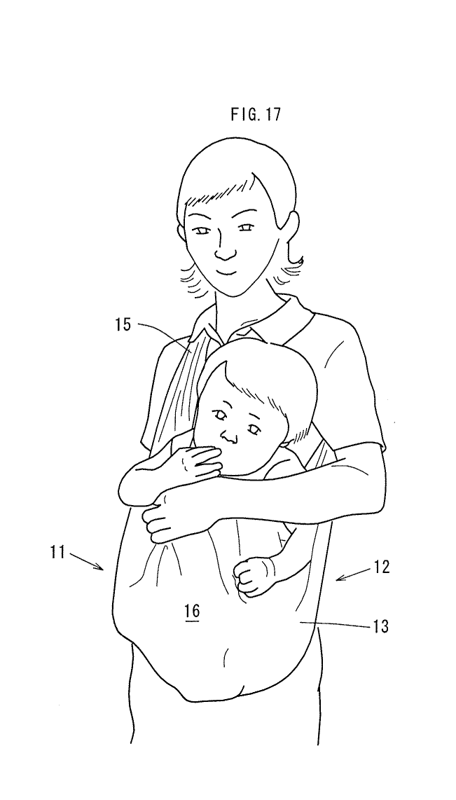

For example, as shown in FIG. 17, the child care giver can wear the baby carrier 11 in a “forward” manner in which the baby/toddler is held while being directed forward. Alternatively, the child care giver can wear the baby carrier 11 in a so-called “vertical and facing” manner (not shown) in which the baby/toddler is held while facing the child care giver.

In the case where the child care giver wears a conventional baby carrier having a sheet-like wrapping portion in the “forward” manner or the “vertical and facing” manner, the child care giver and the baby/toddler face each other without the sheet member interposed therebetween.

Therefore, if the baby/toddler actively moves in the wrapping portion, the baby/toddler may slide down with respect to the child care giver or fall down.

By contrast, the baby carrier 11 in this embodiment, even worn in the “forward” manner or the “vertical and facing” manner, wraps the baby/toddler in the wrapping portion 16. The entire body of the baby/toddler is wrapped around by the wrapping portion 16 of the sheet member 12; i.e., the wrapping portion 16 is interposed also between the child care giver and the baby/toddler.

Therefore, even if the baby/toddler actively moves in the wrapping portion 16, the wrapping portion 16 is prevented from entirely sliding down and the baby/toddler is prevented with certainty from falling down.

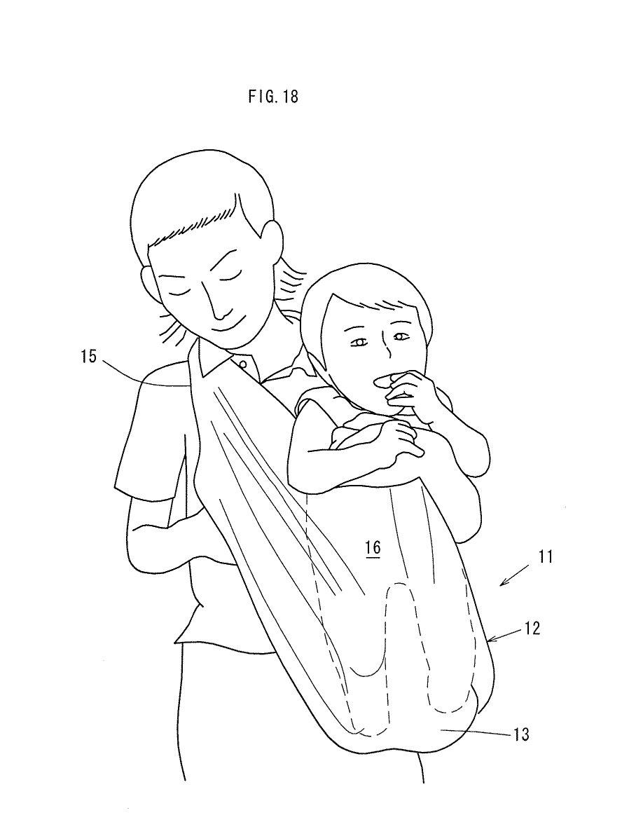

Since the sheet member 12 is expandable, a portion of the wrapping portion 16 which receives the body of the baby/toddler expands in accordance with his/her body weight. Therefore, as shown in FIG. 18, even when the baby/toddler stands up in the wrapping portion 16, his/her bodyweight concentratedly acts on a portion of the wrapping portion 16 which receives the body of the baby/toddler.

As a result, the sheet member 12 expands such that the bag-like wrapping portion 16 becomes deeper. Thus, the baby/toddler can be stably kept without falling down.

Needless to say, the baby carrier 11 in this embodiment may be worn by the child care giver such that the child care giver and the baby/toddler directly face each other without the wrapping portion of the sheet member 12 interposed therebetween.

Hereinafter, a procedure by which the child care giver puts on the baby carrier 11 in this embodiment such that the child care giver and the baby/toddler directly face each other in the “vertical and facing” manner will be described.

First, as shown in FIG. 15, the child care giver puts on the baby carrier 11 in the sash manner, and holds the baby/toddler with, for example, his/her left arm. In this state, the child care giver separates the sheet member 12 from his/her body and quickly causes the baby/toddler to enter the area between the sheet member 12 and his/her body with his/her right hand, without separating the outer cloth sheet 13 and the inner cloth sheet 14 from each other.

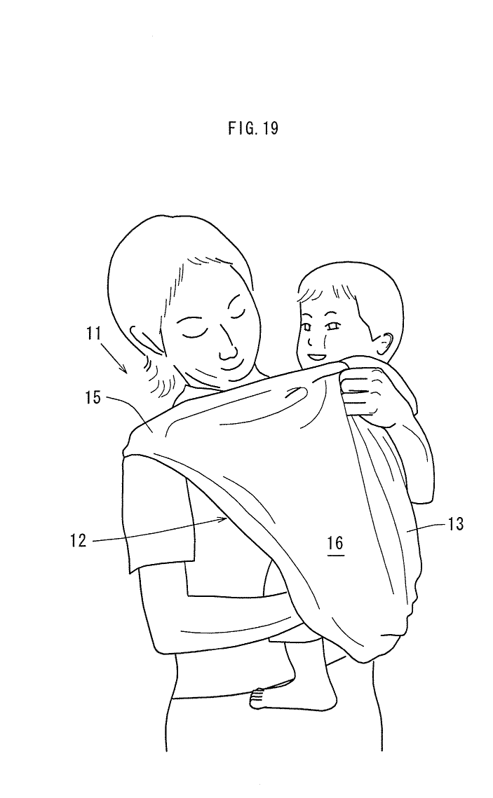

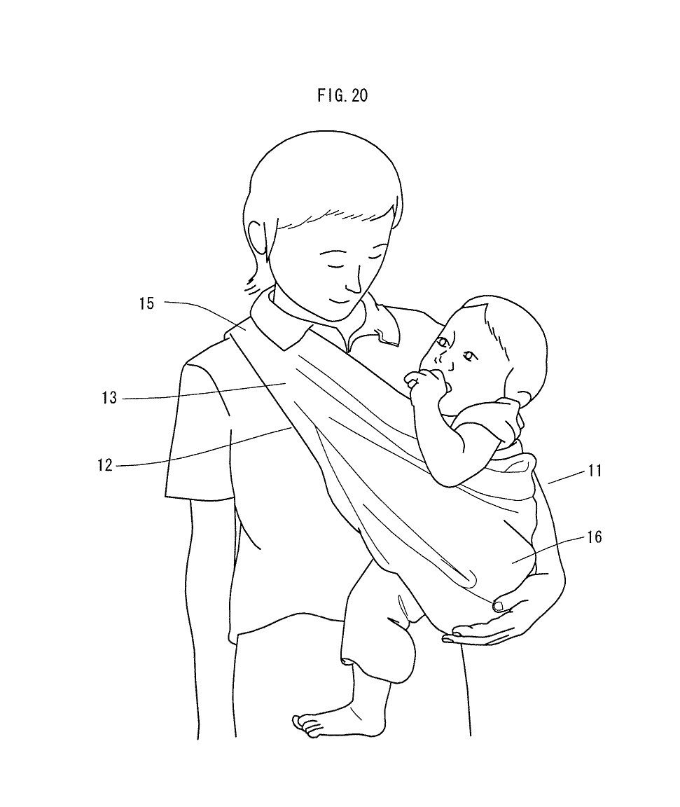

Then, as shown in FIG. 19, the child care giver expands wrinkled parts or the like of the wrapping portion 16 of the sheet member 12 in contact with the back and the buttocks of the baby/toddler. Thus, as shown in FIG. 20, the child care giver can support the baby/toddler in snug contact with the highly expandable sheet member 12.

In this manner, even when the child care giver holds the baby/toddler in the “vertical and facing” manner in which the child care giver and the baby/toddler directly face each other without the sheet member 12 interposed therebetween, the baby carrier 11 in this embodiment is worn with the body, especially the buttocks, of the baby/toddler fitting the sheet member 12. Therefore, the baby/toddler does not slide down or fall down even if he/she moves. The baby/toddler feels comfortable since his/her body fits the flexible sheet member 12.

The sheet member 12 of the baby carrier 11, which has the two-layer structure including the outer cloth sheet 13 and the inner cloth sheet 14, can protect the baby/toddler more securely than a conventional sheet member formed of one piece of cloth.

The baby carrier 11 in this embodiment is entirely formed of the sheet member 12. Owing to this structure, unlike with the conventional art, for example, the baby carrier 11 in this embodiment does not need a separate member such as a coupling member for coupling the belt-shaped element baby carrier, or does not require the wrapping portion to be formed in bellows. Therefore, the baby carrier 11 in this embodiment is easily folded, and is compact when being folded, and thus can be accommodated in a small space.

With the baby carrier 11 in this embodiment, the sheet member 12, or one of the outer cloth sheet 13 and the inner cloth sheet 14, may be formed of a material having a higher air permeability such as a meshed material, or a napped material.

The elements of the above-described embodiment correspond to elements of the following claims as follows. The tucked portions 17a, 17b and 17c correspond to expansion restriction means for restricting the opening edge 12aa.

The center line 18 corresponds to an intermediate portion in the width direction of the sheet member.

Nylon corresponds to an expandable material.

The bottom sewing portion 21 corresponds to expansion restriction means for restricting expansion of an area between the wrapping portion and the shoulder engaging portion in the circumferential direction.

The shoulder sewing portion 22 corresponds to a sewing portion. The present invention is not limited to the above-described embodiment, and may be embodied in various embodiments as described above.

### INDUSTRIAL APPLICABILITY

The present invention is applicable as a product for babies/toddlers, especially as a baby carrier used for holding a baby/toddler.

1. A baby carrier entirely formed of a sheet member and including a wrapping portion for wrapping a baby/toddler and a shoulder engaging portion engageable with a shoulder of a wearer of the baby carrier, wherein:
the wrapping portion is formed to be expandable; and
the wrapping portion has an opening for allowing the baby/toddler to enter or come out from the wrapping portion at a top end thereof, and an opening edge of the opening has expansion restriction means for restricting expansion of the opening edge.

2. A baby carrier according to claim 1, wherein:
the sheet member is formed of one piece of expandable cloth into a ring shape; and
the sheet member is folded along an intermediate portion in a width direction thereof to have a two-layer structure.

3. A baby carrier according to claim 2, wherein the opening edge is shorter than a part of the sheet member having the greatest length in a circumferential direction thereof.

4. A baby carrier according to claim 1, wherein the sheet member is formed of a knit material.

5. A baby carrier according to any one of claims 1 through 4, wherein the sheet member is formed of an expandable material.

6. A baby carrier according to claim 1, wherein the expansion restriction means is provided in an area between the wrapping portion and the shoulder engaging portion in a circumferential direction of the sheet member, for restricting expansion of the area.

7. A baby carrier according to claim 1, wherein an area of the sheet member between the wrapping portion and the shoulder engaging portion in a circumferential direction of the sheet member is formed to become gradually narrower toward the shoulder engaging portion from the wrapping portion.

8. A baby carrier according to claim 1, wherein a portion of the sheet member corresponding to a front part of outfit of the wearer and a portion of the sheet member corresponding to a rear part of the outfit of the wearer have shapes generally matching each other when overlapping each other.

9. A baby carrier according to claim 1, wherein:
the shoulder engaging portion of the sheet member includes a sewing portion, and
the shoulder engaging portion is provided with a shoulder pad.

10. A baby carrier according to claim 1, wherein the expansion restriction means for restricting the expansion of the opening edge is provided at the opening edge between the shoulder engaging portion and the wrapping portion in the circumferential direction of the sheet member.

11. A baby carrier according to claim 3, wherein the expansion restriction means for restricting the expansion of the opening edge is formed by at least one tucked portion.
